(19) United States
(12) Patent Application Publication
(10) Pub. No.: US 2024/0089351 A1
(43) Pub. Date: Mar. 14, 2024

(54) DATA TRANSMISSION CONTROLLERS AND METHODS TO GENERATE DATA TRANSMISSION PACKETS ACCORDING TO MODIFIED QUIC PROTOCOL

(71) Applicant: HUAWEI TECHNOLOGIES CO., LTD., Shenzhen (CN)

(72) Inventors: Ben-Shahar Belkar, Hod Hasharon (IL); Tal Mizrahi, Hod Hasharon (IL); Reuven Cohen, Hod Hasharon (IL)

(21) Appl. No.: 18/499,876

(22) Filed: Nov. 1, 2023

Related U.S. Application Data
(63) Continuation of application No. PCT/EP2021/061712, filed on May 4, 2021.

(51) Int. Cl. H04L 69/164; H04L 69/24

(52) U.S. Cl. CPC H04L 69/164; H04L 69/24

(57) ABSTRACT

A data transmission controller is configured to generate one or more data transmission packets according to the modified QUIC protocol by generating one or more fields in the one or more data transmission packets to have a fixed field-size and generating a predefined number of frames of different frame-types in a predefined frame-type order in the one or more data transmission packets. The data transmission controller enables hardware Offload variant of the QUIC protocol for efficient hardware implementations of the modified QUIC protocol.

### CROSS-REFERENCE TO RELATED APPLICATIONS

This application is a continuation of International Application No. PCT/EP2021/061712, filed on May 4, 2021, the disclosure of which is hereby incorporated by reference in its entirety.

### TECHNICAL FIELD

The present disclosure relates generally to the field of networking and more specifically, to data transmission controllers and methods to generate data transmission packets according to a modified QUIC protocol.

### BACKGROUND

The transmission control protocol (TCP) is a widely used communication protocol that enables exchange of messages between computing devices in a network environment specifically using internet protocol. However, due to high latency in the transmission control protocol (TCP), a QUIC protocol is nowadays used as an internet transport protocol. The QUIC protocol generally runs over the user datagram protocol (UDP). Typically, the QUIC protocol is implemented at a user space of an operating system as opposed to the TCP, which is typically integrated into the operating system. The QUIC protocol is replacing the transport control protocol as the QUIC protocol provides a reliable transport for application protocols that are used to exchange information, such as a third version of the hypertext transfer protocol (HTTPv3).

The QUIC protocol was designed for software implementations, which in comparison to TCP, provides great flexibility to introduce new protocol features without requiring changes in the operating systems. However, as the QUIC protocol provides high security and enhanced recovery and congestion management, the software implementation of the QUIC protocol is very computationally intensive i.e., it requires high CPU utilization. Thus, there is a need for hardware implementation (i.e., hardware offloading of the QUIC protocol). Generally, in the QUIC protocol, QUIC packets are encapsulated with a user datagram protocol header, which appears as user datagram protocol packets to network routers, middle-boxes as well as to the operating system. In general, a header format of the QUIC protocol includes a number of variable-length fields, such as a connection identification (ID), version identification, and the like. However, a complex iterative parsing is required in order to process such variable-length fields. Further, the connection ID which is a first variable-length field of the QUIC protocol, is determined on a per-connection basis, and the connection ID is parse in an incoming QUIC packet. Thus, each endpoint of the QUIC protocol needs to keep a per-connection state that includes the length of the connection ID field in the QUIC protocol. Moreover, the QUIC protocol defines different types of frames, such as STREAM frames, acknowledgment (ACK) frames, and the like, which are included within the QUIC packets, and each frame has its own frame header. Moreover, when the QUIC packet is received, the beginning of the QUIC packet does not include all the frame headers, and additional frame headers may exist deep within the received QUIC packet. Therefore, additional QUIC packet may be required to receive all the frame headers. In addition, the conventional QUIC protocol does not define a specific order of such frames, and thus any combination of frames is possible within the received QUIC packet. Therefore, the aforesaid properties of the QUIC protocol make the QUIC protocol hardware-unfriendly and also makes the QUIC protocol challenging for hardware parsing. Moreover, the flexibility of the QUIC protocol also makes it difficult for hardware implementation because the hardware implementation would require a complex hardware logic and would be inefficient, and thus there exists a technical problem of hardware offloading of the conventional QUIC protocol. In certain scenarios, the QUIC protocol requires expensive resource consumption by hosts that run the QUIC protocol, but the QUIC protocol does not provide a generic application-program interface (API) for applications that require efficient resource consumption by using hardware offloading.

Therefore, in light of the foregoing discussion, there exists a need to overcome the aforementioned drawbacks associated with the hardware offloading of the QUIC protocol.

### SUMMARY

The present disclosure provides data transmission controllers to generate data transmission packets according to a modified QUIC protocol. The present disclosure further provides data transmission methods to generate data transmission packets according to the modified QUIC protocol. The present disclosure provides a solution to the existing problem of the hardware implementations of the conventional QUIC protocol. An objective of the present disclosure is to provide a solution that overcomes at least partially the problems encountered in the prior art and provide improved data transmission controllers and methods to generate data transmission packets according to the modified QUIC protocol for hardware offloading.

One or more objectives of the present disclosure is achieved by the solutions provided in the enclosed independent claims. Advantageous embodiments of the present disclosure are further defined in the dependent claims.

In one aspect, the present disclosure provides a data transmission controller, wherein the data transmission controller is configured to generate one or more data transmission packets according to a modified QUIC protocol, by generating one or more fields in the one or more data transmission packets to have a fixed field-size and generating a predefined number of frames of different frame-types in a predefined frame-type order in the one or more data transmission packets.

The present disclosure provides an improved data transmission controller that is configured to generate one or more data transmission packets according to a modified QUIC protocol, also termed as an Offload variant of the QUIC (or OQUIC) protocol. As one or more data transmission packets include a fixed field-size for the fields and a predefined frame-type order for a predefined number of frames, thus the data transmission controller in comparison to conventional controllers does not require expensive resource consumption to execute hardware Offloading of the QUIC protocol (i.e., OQUIC). Further, due to the fixed size of the fields, the data transmission controller in comparison to conventional controllers does not require complex iterative parsing in order to process one or more fields and also does not need to keep a per-connection state that includes the length of the respective fields. Thus, the present disclosure is very less computationally intensive in comparison to conventional approach. Beneficially, the data transmission controller uses a subset of the functionality of the QUIC protocol in a way that enables hardware Offload variant of the QUIC protocol for efficient hardware implementations of the OQUIC protocol. Thus, the present data transmission controller implementing the OQUIC protocol for hardware Offloading which may potentially be standardized in the Internet Engineering Task Force (IETF) which may further influence and enhance a way people design, use, and manage the Internet.

In an embodiment, the data transmission controller is further configured to limit a number of frames per data transmission packet in the one or more data transmission packets to a defined maximum number of frames per data transmission packet.

By virtue of limiting the number of frames per data transmission packet to the defined maximum number of frames per data transmission packet, hardware parsing of the modified QUIC protocol is manageable within the data transmission controller.

In a further embodiment, the data transmission controller is further configured to set the number of frames per data transmission packet to the defined maximum number of frames per data transmission packet.

By virtue of setting the number of frames per data transmission packet to the defined maximum number of frames per data transmission packet, hardware parsing of the modified QUIC protocol is manageable within the data transmission controller.

In a further embodiment, the data transmission controller is further configured to set all the fields of a field-type to fixed field-type size.

By virtue of setting all the fields of a field-type to fixed field-type size, the data transmission controller does not require a complex iterative parsing to process the fields.

In a further embodiment, the data transmission controller is further configured to include a version number in the one or more data transmission packets, the version number indicating a protocol version to be used.

It is advantageous to include a version number in one or more data transmission packets because the version number indicates a protocol version of the data transmission controller, which is used in the hardware implementation of the modified QUIC protocol based on the required applications.

In a further embodiment, the data transmission controller is further configured to include a mode in the one or more data transmission packets, the mode indicating whether the data transmission packets are to be encrypted or not.

As a mode in one or more data transmission packets is used to indicate whether the data transmission packets are to be encrypted or not. Therefore, the transmission controller with the hardware Offload variant of the QUIC protocol (also referred to as the modified QUIC or OQUIC protocol) is not limited to encryption, as compared to the conventional approach.

In a further embodiment, the data transmission controller further comprising a communication interface, wherein the data transmission controller is further configured to initiate a communication session with a communication device over the communication interface and to define communication parameters during initiation of the communication session, wherein the communication parameters comprises a field size and a frame-type order, and wherein the predefined number of frames is a limited number of frames negotiated on connection establishment with the communication device based on the communication parameters.

As the communication parameters comprises a field size and a frame-type order, therefore, the field size of the fields and the frame-type order of the frames could be fixed to the indicated size (or negotiated to a smaller value) based on the communication parameters during initiation of the communication session with a communication device. Beneficially, the predefined number of frames are constant after connection establishment negotiation, and also remain constant during the lifetime of the connection.

In a further embodiment, the communication parameters further comprises a maximum number of frames per data transmission packet.

A maximum number of frames per data transmission packet are beneficial for hardware parsing of the modified QUIC protocol within the data transmission controller.

In a further embodiment, the field size comprises one or more field-type sizes.

As the field size comprises one or more field-type sizes, thus the data transmission controller does not need to keep the field size (or per-connection state) that includes the field size of one or more fields.

In a further embodiment, at least one of the field-type sizes is zero (0).

Beneficially, at least one of the field-type sizes with zero sizes means the corresponding field doesn't exist, and the corresponding field-type can be reserved for future use.

In a further embodiment, the communication parameters further comprises a parsing depth.

As the communication parameters further comprises a parsing depth, thus the data transmission controller is able to negotiate the parsing depth for hardware parsing of the modified QUIC protocol.

In a further embodiment, the data transmission controller is further configured to negotiate one or more of the communication parameters with the communication device during initialization of the communication session.

By virtue of negotiating one or more of the communication parameters with the communication device during initialization of the communication session, the data transmission controller is flexible in negotiating on different aspects also.

In a further embodiment, the data transmission controller is further configured to execute an application-program interface (API) with two modes: a stream-aware mode and a stream-unaware mode.

It is advantageous to execute an application-program interface (API) with a stream-aware mode and a stream-unaware mode as the data transmission controller provides and enables the generic socket-like application-program interface, which can enable applications to run over the modified QUIC protocol (i.e., the OQUIC protocol) as a replacement to the conventional transmission control protocol (TCP), such as for the applications that require efficient resource consumption by using hardware offloading.

In a further embodiment, the stream-aware mode is based on the generated one or more data transmission packets.

As the stream-aware mode is based on the generated one or more data transmission packets, therefore new application (e.g., a third version of the hypertext transfer protocol) may benefit from the use of multiple QUIC streams (e.g., QUIC streams of data transmission packets) per connection, and use the stream aware application-program interface.

In a further embodiment, the application-program interface (API) is arranged for enabling applications designed for a transmission control protocol (TCP) and user datagram protocol (UDP) protocols to run on a modified QUIC protocol.

As the application-program interface (API) is arranged for enabling applications designed for a transmission control protocol and user datagram protocol (UDP) protocols to run on a modified QUIC protocol (i.e., the OQUIC protocol), therefore the application-program interface executes the legacy applications with no change for the stream-unaware mode.

In a further embodiment, the stream-unaware mode is a transmission control protocol (TCP) Socket application-program interface (API).

As the stream-unaware mode is a transmission control protocol Socket application-program interface, thus there is a generic application-program interface for the modified QUIC protocol, which is running for various applications over hardware offloaded implementation.

In a further embodiment, the stream-unaware mode is a user datagram protocol (UDP) Socket application-program interface (API).

As the stream-unaware mode is a user datagram protocol (UDP) Socket application-program interface, thus there is a generic application-program interface for the modified QUIC protocol, which is running for various applications over hardware offloaded implementation

In a further embodiment, the data transmission controller is configured to handle at least some of the generation in hardware.

It is advantageous to handle at least some of the generation in hardware because the data transmission controller defines possible extensions to the conventional QUIC protocol (or a next-generation of the transmission control protocol) that make it even more versatile in hardware implementations.

In a further embodiment, the data transmission controller is configured to receive a data transmission packet and to parse the received data transmission packet in hardware.

It is advantageous to parse the received data transmission packet in hardware because the data transmission controller defines a subset of the QUIC protocol that makes it hardware-friendly.

In a further embodiment, the data transmission controller is hardware-based.

As the data transmission controller is hardware-based, therefore the data transmission controller allows to significantly improve the performance of hardware-based servers and hosts that run the modified QUIC protocol.

In another aspect, the present disclosure provides a data transmission method for generating one or more data transmission packets comprises generating the one or more data transmission packets according to a modified QUIC protocol, by generating one or more fields in the one or more data transmission packets to have a fixed field-size and generating a predefined number of frames of different frame-types in a predefined frame-type order in the one or more data transmission packets.

The disclosed data transmission method achieves all the technical effects of the data transmission controller of the present disclosure.

In yet another aspect, the present disclosure provides a data transmission, wherein the data transmission controller is configured to: receive incoming data, the incoming data comprising transmission control protocol (TCP) instructions or user datagram protocol (UDP) instructions and instructions according to an application-program interface (API); generate one or more data transmission packets for the modified QUIC protocol according to the TCP instructions or UDP instructions and based on the instructions according to the API, wherein the API comprises two modes: a stream-aware mode and a stream-unaware mode.

The disclosed data controller method achieves all the technical effects of the present disclosure.

In yet another aspect, the present disclosure provides a data transmission method for generating one or more data transmission packets according to the modified QUIC protocol, wherein the method comprises: receiving incoming data, the incoming data comprising transmission control protocol (TCP) instructions or user datagram protocol (UDP) instructions and instructions according to an application-program interface (API); generating one or more data transmission packets for the modified QUIC protocol according to the TCP instructions or UDP instructions and based on the instructions according to the API, wherein the API comprises two modes: a stream-aware mode and a stream-unaware mode.

The disclosed data transmission method achieves all the technical effects of the data transmission controller of the present disclosure.

It is to be appreciated that all the aforementioned embodiments can be combined. It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1A is a block diagram of a data transmission controller, in accordance with an embodiment of the present disclosure;

FIG. 1B is a block diagram of a data transmission controller, in accordance with another embodiment of the present disclosure;

FIG. 2 is a block diagram of a data transmission controller, in accordance with yet another embodiment of the present disclosure;

FIG. 3 is a flowchart of a data transmission method for generating one or more data transmission packets according to the modified QUIC protocol, in accordance with an embodiment of the present disclosure;

FIG. 4 is a flowchart of a data transmission method for generating one or more data transmission packets according to the modified QUIC protocol, in accordance with another embodiment of the present disclosure;

FIG. 5A is a block diagram of a X-over-Offload variant of QUIC (OQUIC) application-program interface, in accordance with an embodiment of the present disclosure; and

FIG. 5B is a block diagram of an X-over-Offload variant of QUIC (OQUIC) application-program interface, in accordance with another embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

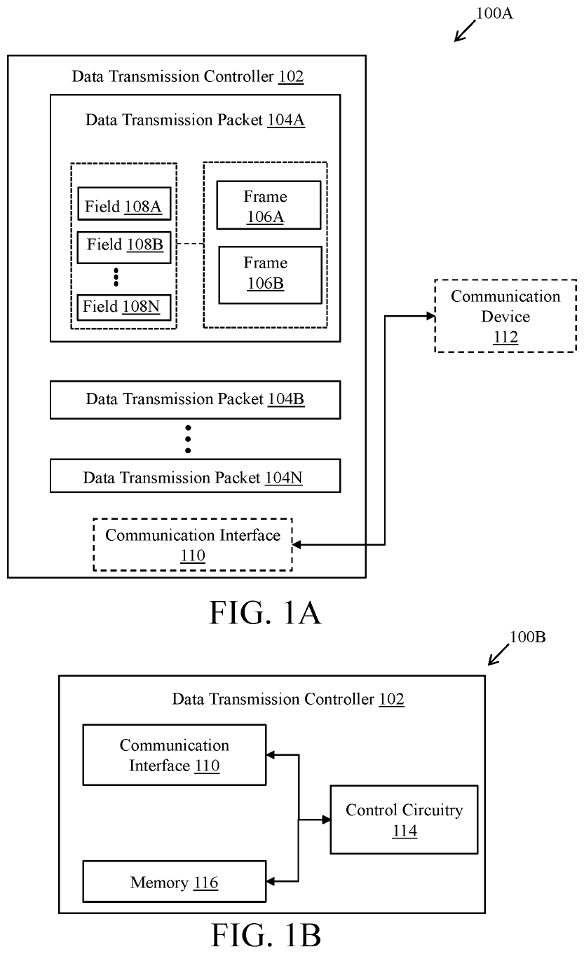

FIG. 1A is a block diagram of a data transmission controller, in accordance with an embodiment of the present disclosure. With reference to FIG. 1A, there is shown a block diagram 100A of a data transmission controller 102. There is further shown one or more data transmission packets 104A to 104N, frames 106A and 106B, one or more fields 108A to 108N, a communication interface 110, and a communication device 112.

In one aspect, the present disclosure provides a data transmission controller 102, wherein the data transmission controller 102 is configured to generate one or more data transmission packets 104A to 104N according to a modified QUIC protocol, by generating one or more fields 108A to 108N in the one or more data transmission packets 104A to 104N to have a fixed field-size and generating a predefined number of frames of different frame-types in a predefined frame-type order in the one or more data transmission packets 104A to 104N.

The data transmission controller 102 include suitable logic, circuitry, interfaces and/or code that is configured to generate one or more data transmission packets 104A to 104N according to the modified QUIC protocol, also termed as Offload variant of the QUIC (or OQUIC) protocol. In an example, the data transmission controller 102 communicates by exchanging one or more data transmission packets 104A to 104N. The data transmission controller 102 may also be referred to as a data transmission device, a controller, a server, a client end, and the like.

One or more data transmission packets 104A to 104N and the frames 106A and 106B are basic units for data transmission used by the modified QUIC protocol. The data transmission packets 104A to 104N are smaller and similar structures of data which are broken down from a data chunk that is to be transmitted. Once received such data transmission packets 104A to 104N are reassembled to the data chunk.

The frames 106A and 106B carry control information and other data which is used by the data transmission controller 102 for communication between endpoints. Example of the frames 106A and 106B includes but not limited to a PING frame, a STREAM frames, an acknowledgment (ACK) frame, and the like.

The fields 108A to 108N are used during transmission of the one or more data transmission packets 104A to 104N. Examples of the fields 108A to 108N include but are not limited to source port, destination port, sequence number, acknowledgment number, header length, flags, window size, and the like.

The communication interface 110 includes suitable logic, circuitry, and/or interfaces that is configured to initiate a communication session with a communication device 112. The communication device 112 includes suitable logic, circuitry, and/or interfaces that enables communication interface 110 to establish a communication session which for example a server. Examples of the communication interface 110 may include, but is not limited to, an antenna, a telematics unit, a radio frequency (RF) transceiver, one or more amplifiers, one or more oscillators, a digital signal processor, a coder-decoder (CODEC) chipset, and/or a subscriber identity module (SIM) card.

In operation, the data transmission controller 102 is configured to generate the one or more data transmission packets 104A to 104N according to a modified QUIC protocol, by generating one or more fields 108A to 108N in the one or more data transmission packets 104A to 104N to have a fixed field-size. The data transmission controller 102 is further configured to generate the one or more data transmission packets 104A to 104N by generating a predefined number of frames of different frame-types in a predefined frame-type order in the one or more data transmission packets 104A to 104N. In other words, the data transmission controller 102 uses the modified QUIC protocol, (or the OQUIC protocol) to generate one or more data transmission packets 104A to 104N, and also to generate the predefined number of frames with different frame-types, such as the frame 106A and the frame 106B. The predefined number of frames may be a limited number of frames negotiated on connection establishment, for example, with the communication device 112. Beneficially as compared to the conventional approach, each of the frames are arranged in a predefined frame-type order within the one or more data transmission packets 104A to 104N, such as within the data transmission packet 104A, as shown in FIG. 1A. In an example, the frames generated by the data transmission controller 102 have a fixed known order between the frame-types, for example, the STREAM frame always precedes the ACK frame. Therefore, a predefined frame-type combination of the frames is possible within one or more data transmission packets 104A to 104N, as compared to the conventional approach. In an implementation, each frame may be associated with one or more fields 108A to 108N. For example, the frame 106A may be associated with field 108A, and the frame 106B may be associated with subsequent fields. Moreover, one or more fields 108A to 108N generated within the one or more data transmission packets 104A to 104N have a fixed field-size (or a constant size), such as the field 108A generated by the data transmission controller 102 have a fixed field-size. In an example, the connection ID (for both source (SRC) and destination (DST)) field, a packet sequence number and other fields as generated by the data transmission controller 102 are considered with a fixed field-size (in bits), as shown in table 1. Therefore, the data transmission controller 102 does not require a complex iterative parsing in order to process the one or more fields 108A to 108N. Further, due to the defined size of the fields 108A to 108N, the data transmission controller 102 does not need to keep a per-connection state that includes the length of the respective fields 108A to 108N, as compared to the conventional approach. In addition, as the data transmission controller 102 is configured to generate one or more data transmission packets 104A to 104N according to the modified QUIC protocol, thus the data transmission controller 102 does not need expensive resource consumption to run the modified QUIC protocol. Moreover, the data transmission controller 102 uses a subset of the functionality of the QUIC protocol in a way that enables hardware offloading of the modified QUIC protocol. In an example, the hardware Offloading of the QUIC protocol is also referred to as the hardware Offload variant of the QUIC protocol (or OQUIC). In an example, the one or more fields 108A to 108N may be part of a modified QUIC header format, and may be part of the frame format for some specific frames of the frames 106A and 106B. There is represented the table 1 below which shows the fixed field-size of different fields such as the fields 108A to 108N. In the table 1 there is shown field name in a first column and corresponding fixed field-size in a second column. In an example, some fields such as “Length (Packet)” in the Table 1 are for the modified QUIC header fields. Further, some fields such as “Length (Frame)” in the Table 1 are for frame fields. Further, some fields are for specific frame types for example, the “ACK Delay” in the Table 1 is used in ACK frame format.

TABLE 1

| Field Name | Length (bits) |
|---|---|
| Stream ID | 32 |
| Offset | 64 |
| Length (Frame) | 32 |
| Length (Packet) | 32 |
| Largest Acknowledged (ACK) | 32 |
| ACK Delay | 32 |
| ACK Range Count | 16 |
| First ACK Range | 16 |
| Gap | 16 |
| ACK Range | 16 |
| ECN Counts | 64 |
| Final (RESET_STREAM) | 64 |
| MAX_DATA | 64 |
| MAX_STREAM_DATA | 64 |
| MAX_STREAMS | 32 |
| DATA_BLOCKED | 64 |
| STREAM_DATA_BLOCKED | 64 |
| STREAMS_BLOCKED | 32 |
| Sequence Number | 32 |
| Frame Type | 32 |
| Reason Phrase Length | 8 |
| Reason Phrase | Up to 2040 |
| Unpredictable Bits (Stateless Reset) | 190 |

In accordance with an embodiment, the data transmission controller 102 is further configured to limit a number of frames per data transmission packet in the one or more data transmission packets 104A to 104N to a defined maximum number of frames per data transmission packet. In other words, an upper bound is defined by the data transmission controller 102 for the number of frames, such as the frame 106A and the frame 106B in the one or more data transmission packets 104A to 104N. In an example, a maximum number of frames per data transmission packet is limited to two frames per data transmission packet 104A to 104N. For example, the frames 106A and 106B are limited by the data transmission controller 102 for the data transmission packet 104A, and the subsequent two frames are limited by the data transmission controller 102 for the data transmission packet 104B. Moreover, when the data transmission packets 104A and 104B are received by a receiver then the beginning of each of the data transmission packets 104A and 104B will include all headers of each frame. For example, the beginning of the data transmission packets 104A includes the headers of the frames 106A and 106B. Similarly, the beginning of the data transmission packets 104B includes the headers of the subsequent two frames. Therefore, no additional frames (and headers) will exist deep within the data transmission packets 104A and 104B, making it easy for hardware parsing of the modified QUIC protocol within the data transmission controller 102. An example of a short header for a frame is shown below in table 2. There is represented the table 2 below which shows the beginning of a data transmission packet (e.g., the data transmission packet 104A). The beginning of a data transmission packet (in row 1) includes a short header (in row 2), and no additional frame exists within the corresponding data transmission packet, as shown in row 2 of the table 2. There is further shown a destination connection ID (along with length in bits), a packet number (along with length in bits), and a payload of the corresponding data transmission packet.

TABLE 2

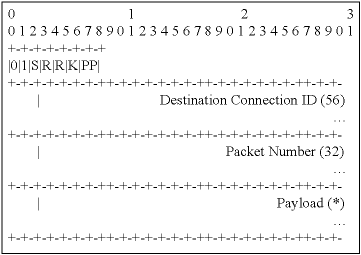

In accordance with an embodiment, the data transmission controller 102 is further configured to set the number of frames per data transmission packet to the defined maximum number of frames per data transmission packet 104A to 104N. In other words, a fixed number is defined by the data transmission controller 102 for the number of frames per data transmission packet. In an example, a maximum number of frames per data transmission packet 104A to 104N is set to two number of frames per data transmission packet 104A to 104N, such as the frames 106A and 106B are set (or fixed) by the data transmission controller 102 for the data transmission packet 104A, and the like. Moreover, when one or more data transmission packets 104A to 104N are received by a receiver, then the beginning of each of the data transmission packets 104A to 104N will include all the headers of corresponding frames. Therefore, no additional frames (and headers) will exist deep within the data transmission packets 104A to 104N, making it easy for hardware parsing of the modified QUIC protocol within the data transmission controller 102.

In accordance with an embodiment, the data transmission controller 102 is further configured to set all the fields 108A to 108N of a field-type to fixed field-type size. In other words, the field-type of all the fields 108A to 108N is set to the fixed field-type size. Thus, different fields 108A to 108N of different field-type will have fixed field-type sizes, and the data transmission controller 102 does not require a complex iterative parsing to process the all fields 108A to 108N.

In accordance with an embodiment, the data transmission controller 102 is further configured to include a version number in the one or more data transmission packets 104A to 104N, the version number indicating a protocol version to be used. In other words, one or more data transmission packets 104A to 104N generated according to the modified QUIC protocol includes the version number indicating a protocol version to be used. In an example, the version number indicating the protocol version is used to enable identification of the modified QUIC protocol of the present disclosure which is also referred to as hardware offload variant of the QUIC protocol (or OQUIC). Moreover, the version number indicates the protocol version of the hardware Offload variant of the QUIC protocol based on the required applications of the data transmission controller 102.

In other words, in this embodiment, the data transmission controller 102, implements the hardware Offload variant of the QUIC protocol that includes extensions and tweaks that are not defined in the standard specification of the QUIC protocol. Specifically, the hardware Offload variant of the QUIC protocol may use a different version number (or a new version) other than the standard QUIC protocol and may include new parameters, which are not used in the standard QUIC protocol.

In accordance with an embodiment, the data transmission controller 102 is further configured to include a mode in the one or more data transmission packets 104A to 104N, the mode indicating whether the data transmission packets 104A to 104N are to be encrypted or not. In other words, the mode (e.g., an unsecured mode of operation) included by the data transmission controller 102 in the one or more data transmission packets 104A to 104N indicates whether one or more data transmission packets 104A to 104N are to be encrypted or not. In an example, encryption of one or more data transmission packets 104A to 104N is disabled in the mode, such as in the unsecured mode of operation, which may be used for internal domains and confined networks. Beneficially in comparison with the conventional approach, the data transmission controller 102 with the hardware Offload variant of the QUIC protocol is not limited to encryption.

In other words, in this embodiment, the data transmission controller 102 allows interoperability with standard implementations of the modified QUIC protocol by configuring a standard implementation to a specific mode of operation that complies with the previous properties (or falling back to the standard QUIC protocol). For example, if most nodes (i.e. devices participating in a network) in the network support the hardware offloading of the QUIC protocol, then it is possible to use the modified QUIC protocol with hardware offloading. Moreover, connections with the nodes that do not support the hardware offloading of the QUIC protocol can be made using the standard QUIC protocol with a software implementation (i.e. conventional way of QUIC protocol). Therefore the data transmission controller 102 allows interoperability with a relatively small performance penalty.

In accordance with an embodiment, the data transmission controller 102 further comprises a communication interface 110. The data transmission controller 102 is further configured to initiate a communication session with a communication device 112 over the communication interface 110. The data transmission controller 102 is further configured to define communication parameters during initiation of the communication session, wherein the communication parameters comprises a field size and a frame-type order, and wherein the predefined number of frames is a limited number of frames negotiated on connection establishment with the communication device 112 based on the communication parameters. In other words, the data transmission controller 102 comprises the communication interface 110, which is used to initiate the communication session (or connection establishment) with a communication device 112. Moreover, during the initiation of the communication session, the communication parameters are defined by the data transmission controller 102, where the communication parameters include the field size of the fields 108A to 108N and the frame-type order of the predefined number of frames, such as the frame 106A and the frame 106B. Therefore, the field size of the fields 108A to 108N and the frame-type order of the frames could be fixed to the indicated size, such as negotiated to a smaller value based on the communication parameters during initiation of the communication session with the communication device 112. The communication parameters are further used to negotiate the predefined number of frames, such as the frame 106A and the frame 106B to a limited (or constant) number of frames on connection establishment with the communication device 112. Beneficially in comparison with the conventional QUIC protocol, the predefined number of frames in the modified QUIC protocol are constant after connection establishment negotiation, and also remain constant during the lifetime of the connection.

In other words, the data transmission controller 102 is configured to define the communication parameters (or means) so as to negotiate the modified QUIC protocol properties based on the communication parameters, such as the field size (or length) of the fields 108A to 108N and the frame-type order of the frames, such as the frames 106A and 106B. In an example, the communication parameters can be negotiated during communication session initialization, and once negotiated, the communication parameters will remain fixed during the lifetime of the communication session (or connection). Further, based on the version as well as hardware capabilities of the modified QUIC protocol, the communication parameters will be fixed during the lifetime of all connections.

In accordance with an embodiment, the communication parameters further comprises a maximum number of frames per data transmission packet. In an example, after the initiation of the communication session, the data transmission packets 104A to 104N are generated based on the communication parameters, which comprises the maximum number of frames per data transmission packet, such as up to two frames 106A and 106B per data transmission packet. Moreover, when the data transmission packets 104A and 104B are received (e.g., by the communication device 112 or by the data transmission controller 102), then a beginning of each of the data transmission packets 104A and 104B will include all headers of each frame. Therefore, in comparison to conventional approach, no additional frame (and headers) will exist deep within the data transmission packets 104A and 104B, which makes it easy for hardware parsing of the modified QUIC protocol within the data transmission controller 102.

In accordance with an embodiment, the field size comprises one or more field-type sizes. Therefore, during the initiation of the communication session, the field size of one or more fields 108A to 108N could be fixed to the indicated size (or negotiated to a smaller value) based on the one or more field-type sizes. Moreover, the data transmission controller 102 need not keep the field size (or per-connection state) that includes the field size of one or more fields 108A to 108N.

In accordance with an embodiment, at least one of the field-type sizes is zero. In other words, at least one of the fields 108A to 108N can be negotiated on size zero based on the field-type sizes, which means the corresponding field doesn't exist, and the corresponding field may be reserved for future use.

In accordance with an embodiment, the communication parameters further comprises a parsing depth. As the communication parameters comprise the parsing depth, thus the data transmission controller 102 can negotiate the parsing depth for hardware parsing of the modified QUIC protocol.

In accordance with an embodiment, the data transmission controller 102 is further configured to negotiate one or more of the communication parameters with the communication device 112 during initialization of the communication session. As a result, the data transmission controller 102 with the hardware Offload variant of the QUIC protocol is flexible to negotiate on different aspects also.

In accordance with an embodiment, the data transmission controller 102 is further configured to execute an application-program interface (API) with two modes: a stream-aware mode and a stream-unaware mode. In other words, the data transmission controller 102 is configured to execute the application-program interface. Moreover, the application-program interface enables two modes of operation, such as the stream-aware mode and the stream-unaware mode. In an example, the stream-aware mode is aware of QUIC streams (e.g., QUIC streams of one or more data transmission packets 104A to 104N) and also allows an application (e.g., a web application) to define multiple QUIC streams. In contrast, the stream-unaware mode is not aware of the QUIC streams.

Therefore, the data transmission controller 102 with the Offload variant of the QUIC protocol is highly useful in performance-sensitive environments (i.e. which require low latency), for example, hypertext transfer protocol secure (HTTPS) web servers. Further, the Offload variant of the QUIC protocol may be used for non-HTTP applications also, that run over the conventional QUIC protocol. Moreover, the data transmission controller 102 provides and enables the generic socket-like application-program interface and enables applications to run over the modified QUIC protocol to replace the conventional transmission control protocol (TCP), such as for the applications that require efficient resource consumption by using hardware offloading.

In an implementation, the data transmission controller 102 executes the application-program interface that may be designed in a versatile way that allows various application types to run over the Offload variant of the QUIC protocol. Examples of such application types include but are not limited to remote direct memory access (RDMA) and various other applications that are either stream-aware or stream-unaware. Since QUIC streams are a notion that does not exist in transmission control protocol, thus it is expected that legacy applications may need to run transparently over the data transmission controller 102 with the Offload variant of the QUIC protocol in a stream-unaware manner. Moreover, the legacy applications such as secure shell protocol (SSH) (or file transfer protocol (FTP)) may run over the stream-unaware application-program interface in a way that allows smooth migration from existing implementations.

In accordance with an embodiment, the stream-aware mode is based on the generated one or more data transmission packets 104A to 104N. As the stream-aware mode is based on one or more data transmission packets 104A to 104N, thus new applications (e.g., a third version of the hypertext transfer protocol) may benefit from the use of multiple QUIC streams per connection and use the stream aware application-program interface. Moreover, the application is written in the stream-aware mode run over the modified QUIC protocol and knows the different application-program interface calls of the modified QUIC protocol specifics.

In accordance with an embodiment, the application-program interface (API) is arranged for enabling applications designed for a transmission control protocol (TCP) and user datagram protocol (UDP) protocols to run on a modified QUIC protocol. In other words, the application-program interface executes the stream-unaware mode, which runs the legacy applications with no change, i.e. the legacy applications consider they are running over a transmission control protocol (or a user datagram protocol socket). Moreover, the data transmission controller 102 executes a special application-program interface to bridge the differences to the modified QUIC protocol and vice versa back to the original on the receiver, such as the data transmission controller 102.

In accordance with an embodiment, the stream-unaware mode is a transmission control protocol (TCP) Socket application-program interface (API). In an implementation, the transmission control protocol socket application-program interface may hide whether the QUIC protocol is offloaded by hardware or not in the stream-unaware mode, which is not aware of the QUIC protocol based streams. Thus, few connections, such as with another communication device, may be offloaded in hardware, while others connections may run in software. For example, QUIC standard connections are offloaded in software, and the Offload variant of the QUIC (OQUIC) connections are offloaded in hardware. Therefore, there is a generic application-program interface for the QUIC protocol that appears to the application as the transmission control protocol socket application-program interface, which is running for various applications over hardware offloaded implementation. Further, the application is using the transmission control protocol application-program interface which is later bridged to the OQUIC application-program interface, which is offloaded to the hardware.

In accordance with an embodiment, the stream-unaware mode is a user datagram protocol (UDP) Socket application-program interface (API). In an implementation, the user datagram protocol socket application-program interface may hide whether the modified QUIC protocol is offloaded by hardware or not in the stream-unaware mode. Thus, few connections, such as with other communication devices, may be offloaded in hardware, while other connections may run in software. For example, QUIC standard connections are offloaded in software, and the Offload variant of the QUIC connections is offloaded in hardware. Therefore, there is a generic application-program interface for the modified QUIC protocol that appears to the application as the user datagram protocol socket application-program interface.

In accordance with an embodiment, the data transmission controller 102 is configured to handle at least some of the generation in hardware. In other words, the data transmission controller 102 is configured to handle at least some of the generation in hardware Offload variant of the modified QUIC protocol. Thus, the data transmission controller 102 defines possible extensions to the conventional QUIC protocol (or a next-generation of transmission control protocol) that make it even more versatile in hardware implementations.

In accordance with an embodiment, the data transmission controller 102 is configured to receive a data transmission packet and to parse the received data transmission packet in a hardware. In other words, the data transmission controller 102 is configured to receive the data transmission packet, such as the data transmission packet 104A from a communication device such as communication device 112. Optionally, the beginning of the received data transmission packet includes all the headers and makes the data transmission controller 102 hardware-oriented. Moreover, the data transmission controller 102 defines a subset of the QUIC protocol that makes it hardware-friendly.

In accordance with an embodiment, the data transmission controller 102 is hardware-based. In other words, the data transmission controller 102 is efficient for hardware implementations of the modified QUIC protocol. Moreover, the data transmission controller 102 allows to significantly improve the performance of hardware-based servers and hosts that run the modified QUIC protocol.

Therefore, the data transmission controller 102 uses a subset of the functionality of the QUIC protocol in a way that enables hardware offloading of the QUIC protocol. As the data transmission controller 102 is configured to generate one or more data transmission packets 104A to 104N according to the modified QUIC (or OQUIC) protocol, thus the data transmission controller 102 does not need expensive resource consumption to run the modified QUIC protocol. Further, due to the fixed size of the fields 108A to 108N, the data transmission controller 102 does not require the complex iterative parsing in order to process the one or more fields 108A to 108N, and also does not need to keep a per-connection state that includes the length of the respective fields 108A to 108N. The hardware Offloading of the QUIC protocol is used for remote direct memory access over QUIC elastic transport (RoQET), which is an alternative to remote direct memory access (RDMA)-over-converged-Ethernet (RoCE) that provides reliability and low latency and can be deployed over a wide area network (WAN). Another potential use case of the hardware Offloading of the QUIC protocol is non-volatile-memory-express (NVMe)-over-QUIC, which may be an alternative for non-volatile-memory-express (NVMe)-over-fabric, and NVMe-over-TCP which suffers from the TCP issue that QUIC came to solve.

The present disclosure provides efficient hardware implementations of the modified QUIC protocol. The present disclosure further allows to significantly improve the performance of servers and hosts that run the modified QUIC protocol and provides a generic application-program interface to run various applications over hardware offloaded implementation. Thus, the present data transmission controller 102 implementing the hardware Offload variant of the QUIC protocol (also termed as OQUIC) may potentially be standardized in the Internet Engineering Task Force (IETF) which may further influence and enhance a way people design, use, and manage the Internet.

FIG. 1B is a block diagram of a data transmission controller, in accordance with another embodiment of the present disclosure. FIG. 1B is shown in conjunction with elements from FIG. 1A. With reference to FIG. 1B, there is shown a block diagram 100B of the data transmission controller 102. In an implementation, the data transmission controller 102 further includes a control circuitry 114, a memory 116 and the communication interface 110.

In this implementation, the operations executed by the data transmission controller 102 may be executed and controlled by the control circuitry 114. Examples of the control circuitry 114 may include, but is not limited to, a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, and other processors or circuitry.

The memory 116 includes suitable logic, circuitry, and/or interfaces that is configured to store one or more data transmission packets 104A to 104N generated by the data transmission controller 102. Examples of implementation of the memory 116 may include, but are not limited to, Electrically Erasable Programmable Read-Only Memory (EEPROM), Dynamic Random Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory. The communication interface 110 may also be referred to as a network interface that includes suitable logic, circuitry, and/or interfaces that is configured to communicate with the external devices like communication device 112 of FIG. 1A.

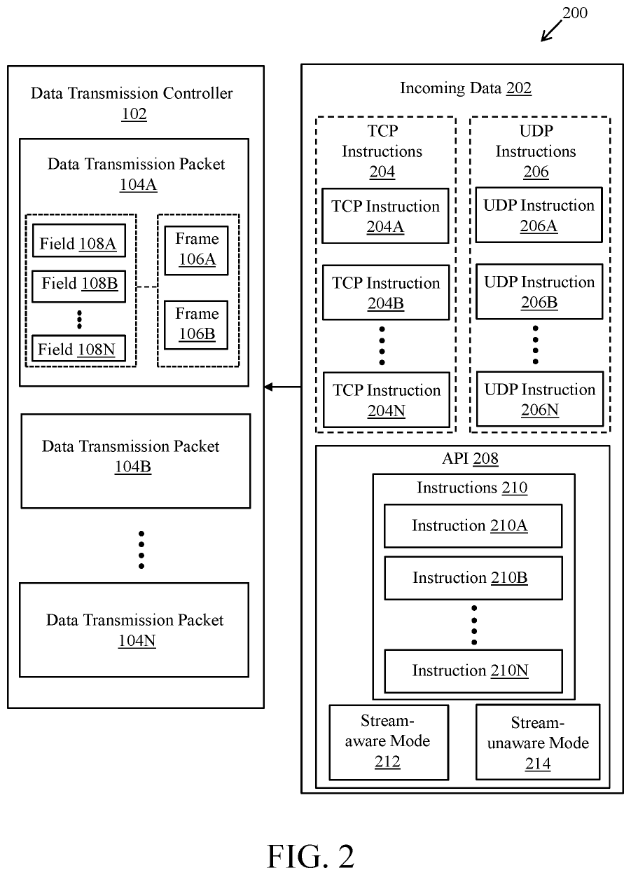

FIG. 2 is a block diagram of a data transmission controller, in accordance with yet another embodiment of the present disclosure. FIG. 2 is shown in conjunction with elements from the FIGS. 1A and 1B. With reference to FIG. 2, there is shown a block diagram 200 of the data transmission controller 102 and an incoming data 202. The incoming data 202 includes transmission control protocol (TCP) instructions 204 or user datagram protocol (UDP) instructions 206. The incoming data 202 further includes instructions 210 according to an application-program interface (API) 208. The application-program interface 208 includes a stream-aware mode 212 and a stream-unaware mode 214.

The incoming data 202 comprises the transmission control protocol instructions 204, user datagram protocol) instructions 206, and instructions 210 according to the application-program interface 208. In an example, the incoming data 202 is received from a network sniffer, such as wire, where both the stream aware and stream unaware modes are OQUIC packets, such as the data transmission packets 104A to 104N. Further, the conversion of the incoming data 202 is done on a software/firmware/hardware (SW/FW/HW) layer that changes the transmission control protocol instructions 204 to OQUIC and on the network sniffer the packets, such as the data transmission packets 104A to 104N will look as OQUIC packets. In other words, on the network sniffer (or wire), the incoming data 202 includes OQUIC packets. Optionally, the transmission control protocol instructions 204, user datagram protocol instructions 206, and instructions 210 of the incoming data 202 corresponds to an order of sequences given to the data transmission controller 102. The transmission control protocol instructions 204 further includes a plurality of transmission control protocol instructions 204A to 204N, and the user datagram protocol instructions 206 also includes a plurality of user datagram protocol instructions 206A to 206N. Similarly, the instructions 210 from the application-program interface 208 also includes a plurality of instructions 210A to 210N.

The stream-aware mode 212 corresponds to a mode which is aware of QUIC streams, and the stream-unaware mode 214 corresponds to mode which is not aware of the QUIC streams.

In another aspect, the present disclosure provides a data transmission controller 102, wherein the data transmission controller 102 is configured to:
receive incoming data 202 (e.g. from an application layer), the incoming data 202 comprising transmission control protocol (TCP) instructions 204 or user datagram protocol (UDP) instructions 206 and instructions 210 according to an application-program interface (API) 208;
generate one or more data transmission packets 104A to 104N for the modified QUIC protocol according to the transmission control protocol (TCP) instructions 204 or user datagram protocol (UDP) instructions 206 and based on the instructions 210 according to the application-program interface (API) 208, wherein the application-program interface (API) 208 comprises two modes: a stream-aware mode 212 and a stream-unaware mode 214.

In operation, the data transmission controller 102 is configured to receive the incoming data 202. The incoming data 202 comprises the transmission control protocol instructions 204 or the user datagram protocol instructions 206, and the instructions 210 according to the application-program interface 208. The data transmission controller 102 is configured to generate one or more data transmission packets 104A to 104N for the modified QUIC protocol according to the transmission control protocol instructions 204 or the user datagram protocol instructions 206 and based on the instructions 210 according to the application-program interface 208, wherein the application-program interface 208 comprises two modes, a stream-aware mode 212 and a stream-unaware mode 214. In other words, the data transmission controller 102 receives the incoming data 202 and generates one or more data transmission packets 104A to 104N for the modified QUIC (i.e., OQUIC) protocol, such as to generate the data transmission packet 104A for the modified QUIC protocol. In an implementation, the incoming data 202 is received from the application layer through a communication interface, and the incoming data 202 includes a field size for the fields 108A to 108N and a predefined frame-type order for the frames. As the incoming data 202 includes the transmission control protocol instructions 204 (or user datagram protocol instructions 206) and the instructions 210 from the application-program interface 208. Therefore, the data transmission controller 102 generates one or more data transmission packets 104A to 104N for the modified QUIC protocol according to the transmission control protocol instructions 204 (or user datagram protocol instructions 206), and also based on instructions 210 from the application-program interface 208. In an implementation, the application-program interface 208 is executed by the data transmission controller 102, and the application-program interface 208 includes the stream-aware mode 212 and the stream-unaware mode 214. Therefore, the data transmission controller 102 uses the modified QUIC protocol, such as the Offload variant of the QUIC protocol, which may be useful in performance sensitive environments, for example, hypertext transfer protocol secure (HTTPS) web servers. In addition, the Offload variant of the QUIC protocol may be used for non-HTTP applications also, that run over the conventional QUIC protocol as well. Thus, the data transmission controller 102 provides and enables the generic socket-like application-program interface 208, which can enable applications to run over the modified QUIC protocol as a replacement to the conventional transmission control protocol (TCP), such as for the applications that require efficient resource consumption by using hardware offloading.

In an implementation, the data transmission controller 102 executes the application-program interface 208 that may be designed in a versatile way that allows various application types to run over the Offload variant of the QUIC protocol. Examples of the application types include but are not limited to remote direct memory access (RDMA) and various other applications that are either from the stream-aware mode 212 or from the stream-unaware mode 214. Since QUIC streams are a notion that does not exist in transmission control protocol, thus it is expected that legacy applications may need to run transparently over the data transmission controller 102 with the Offload variant of the QUIC protocol in a stream-unaware manner. Moreover, the legacy applications, such as a secure shell protocol (SSH) (or file transfer protocol (FTP)) may run over the stream-unaware application-program interface in a way that allows smooth migration from existing implementations.

As the data transmission controller 102 is configured to generate one or more data transmission packets 104A to 104N for the modified QUIC protocol, thus the data transmission controller 102 does not need expensive resource consumption to run the modified QUIC protocol. Moreover, the data transmission controller 102 uses a subset of the functionality of the QUIC protocol in a way that enables hardware offloading of the QUIC protocol.

In accordance with an embodiment, the stream-unaware mode 214 is a transmission control protocol (TCP) Socket application-program interface (API). In an implementation, the transmission control protocol socket application-program interface may hide whether the modified QUIC protocol is offloaded by hardware (or not) in the stream-unaware mode 214, which is not aware of the QUIC streams. Thus, few connections, such as connection with other communication devices, may be offloaded in hardware, while others connections may run in software. For example, QUIC standard connections are offloaded in software, and the Offload variant of the QUIC (OQUIC) connections are offloaded in hardware. Therefore, there is a generic application-program interface for the modified QUIC protocol that appears to the application as the transmission control protocol socket application-program interface, which is running for various applications over hardware offloaded implementation.

In accordance with an embodiment, the stream-unaware mode 214 is a user datagram protocol (UDP) Socket application-program interface (API). In an implementation, the user datagram protocol socket application-program interface may hide whether the modified QUIC protocol is offloaded by hardware or not in the stream-unaware mode 214. Thus, few connections, such as connection with other communication devices, may be offloaded in hardware, while others connections may run in software. For example, QUIC standard connections are offloaded in software, and the Offload variant of the QUIC connections is offloaded in hardware. Therefore, there is a generic application-program interface for the modified QUIC protocol that appears to the application as the user datagram protocol socket application-program interface.

In accordance with an embodiment, the stream-aware mode 212 comprises instructions for generating the one or more data transmission packets 104A to 104N by generating one or more fields 108A to 108N in the one or more data transmission packets 104A to 104N to have a fixed field-size and generating a predefined number of frames of different frame-types in a predefined frame-type order in the one or more data transmission packets 104A to 104N. In other words, the data transmission controller 102 is configured to receive instructions from the stream-aware mode 212 of the application-program interface 208. The instructions received from the stream-aware mode 212 are further used to generate the fixed field-size for the fields 108A to 108N and a predefined frame-type order for the predefined number of frames, such as the frame 106A and the frame 106B. Thereafter, one or more data transmission packets 104A to 104N is generated (e.g., for the OQUIC protocol), which includes the fixed field-size for the fields 108A to 108N and a predefined frame-type order for the predefined number of frames. For example, the data transmission packet 104A is generated from the instructions received from the stream-aware mode 212, and the data transmission packet 104A includes the fixed field-size for the fields 108A to 108N and the predefined frame-type order for the predefined number of frames, as shown in FIG. 2. Therefore, a predefined frame-type combination of predefined number of frames, such as the frame 106A and the frame 106B is possible within one or more data transmission packets 104A to 104N. Moreover, due to the fixed size of the fields 108A to 108N, the data transmission controller 102 does not require a complex iterative parsing in order to process the one or more fields 108A to 108N within the one or more data transmission packets 104A to 104N.

In accordance with an embodiment, the stream-aware mode 212 comprises instructions for limiting the number of frames per data transmission packet in the one or more data transmission packets 104A to 104N to a defined maximum number of frames per data transmission packet. In other words, the instructions from the stream-aware mode 212 are used by the data transmission controller 102 to define an upper bound for the number of frames in the one or more data transmission packets 104A to 104N, such as for the data transmission packet 104A and 104B. In an example, a maximum number of frames per data transmission packet is limited to two frames per data transmission packet 104A to 104N. For example, the frames 106A and 106B are limited by the data transmission controller 102 for the data transmission packet 104A, and the subsequent two frames are defined by the data transmission controller 102 for the data transmission packet 104B. Moreover, when the data transmission packets 104A and 104B are received by a receiver (e.g., a communication device), then the beginning of each of the data transmission packets 104A and 104B will include all headers of each frame. For example, the beginning of the data transmission packets 104A includes the headers of the frames 106A and 106B. Similarly, the beginning of the data transmission packets 104B includes the headers of the subsequent two frames. Therefore, no additional frames (and headers) will exist deep within the data transmission packets 104A and 104B, which makes it easy for hardware parsing of the modified QUIC protocol within the data transmission controller 102.

In accordance with an embodiment, the stream-aware mode 212 comprises instructions for setting all the fields of a field-type to fixed field-type size. In other words, the instructions from the stream-aware mode 212 are used by the data transmission controller 102 to set the field-type of all the fields 108A to 108N to the fixed field-type size. Thus, different fields 108A to 108N of different field-type will have different fixed field-type sizes, and the data transmission controller 102 in comparison to conventional approach does not require a complex iterative parsing in order to process all fields 108A to 108N.

In accordance with an embodiment, the stream-aware mode 212 comprises instructions for handling at least some of the generation in hardware. As the instructions from the stream-aware mode 212 are used by the data transmission controller 102 to handle at least some of the generation in hardware. Therefore, the data transmission controller 102 defines possible extensions to the conventional QUIC protocol (or a next-generation of transmission control protocol) that make it even more versatile in hardware implementations.

Therefore, the data transmission controller 102 uses a subset of the functionality of the QUIC protocol in a way that enables hardware offloading of the QUIC protocol. The present disclosure provides efficient hardware implementations of the modified QUIC protocol. The present disclosure further allows to significantly improve the performance of servers and hosts that run the modified QUIC protocol and provides a generic application-program interface 208 to run various applications over hardware offloaded implementation. Thus, the present data transmission controller 102 implementing the hardware Offload variant of the QUIC protocol (also termed as OQUIC) may potentially be standardized in the Internet Engineering Task Force (IETF) which may further influence and enhance the way people design, use, and manage the Internet.

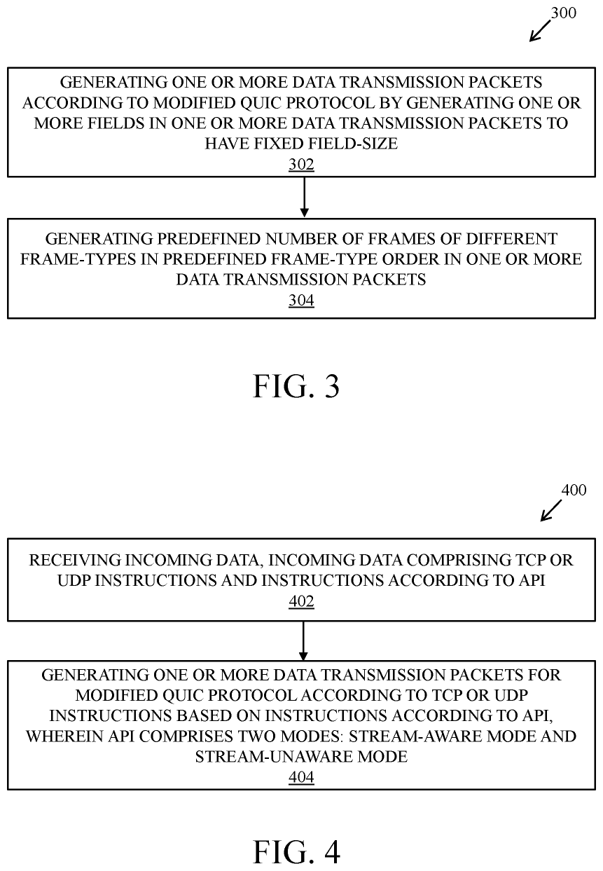

FIG. 3 is a flowchart of a data transmission method for generating one or more data transmission packets according to the modified QUIC protocol, in accordance with an embodiment of the present disclosure. FIG. 3 is shown in conjunction with elements from FIGS. 1A, 1B, and FIG. 2. With respect to FIG. 3, there is shown a data transmission method 300 for generating one or more data transmission packets 104A to 104N according to the modified QUIC protocol. The data transmission method 300 includes steps 302 and 304.

In yet another aspect, the present disclosure provides a data transmission method 300 for generating one or more data transmission packets 104A to 104N comprises generating the one or more data transmission packets 104A to 104N according to a modified QUIC protocol, by generating one or more fields 108A to 108N in the one or more data transmission packets 104A to 104N to have a fixed field-size and generating a predefined number of frames of different frame-types in a predefined frame-type order in the one or more data transmission packets 104A to 104N.

The present disclosure provides the data transmission method 300 for generating one or more data transmission packets 104A to 104N according to the modified QUIC protocol. The data transmission method 300 uses a subset of the functionality of the QUIC protocol in a way that enables hardware offloading of the QUIC protocol. As the data transmission method 300 is configured to generate one or more data transmission packets according to the modified QUIC protocol, thus the data transmission method 300 does not need requires expensive resource consumption to run the modified QUIC protocol. Moreover, the data transmission method 300 uses a subset of the functionality of QUIC in a way that enables hardware offloading of the QUIC protocol.

At step 302, the data transmission method 300 comprises generating the one or more data transmission packets 104A to 104N according to a modified QUIC protocol, by generating one or more of the fields 108A to 108N in the one or more data transmission packets 104A to 104N to have a fixed field-size. In other words, the data transmission method 300 uses the modified QUIC protocol for generating the fixed field-size for the fields 108A to 108N. Thereafter, one or more data transmission packets 104A to 104N are generated (e.g., for the modified QUIC protocol), which includes the fixed field-size for the fields 108A to 108N. For example, the data transmission packet 104A includes the fixed field-size for the fields 108A to 108N. In an example, the connection ID (for both source (SRC) and destination (DST)) field, packet sequence number, and other fields as generated by the data transmission method 300 are considered with a defined (or fixed) field-size (in bits). Therefore, due to the defined size of the fields 108A to 108N, the data transmission method 300 does not require a complex iterative parsing in order to process the one or more fields 108A to 108N within the one or more data transmission packets 104A to 104N.

At step 304, the data transmission method 300 further comprises generating a predefined number of frames of different frame-types in a predefined frame-type order in the one or more data transmission packets 104A to 104N. In other words, the data transmission method 300 uses the modified QUIC protocol for generating the predefined frame-type order for the predefined number of frames, such as the frame 106A and the frame 106B. Thereafter, one or more data transmission packets 104A to 104N are generated (e.g., for the modified QUIC protocol), which includes the predefined frame-type order for the predefined number of frames. Moreover, each frame is arranged in a predefined frame-type order within the one or more data transmission packets 104A to 104N. For example, the data transmission packet 104A includes the predefined frame-type order for the frames 106A and 106B. Alternatively, the frames 106A and 106B generated by the data transmission method 300 have fixed known order between the frame-types, such as the STREAM frame always precedes the ACK frame. Therefore, a predefined frame-type combination of frames is possible within one or more data transmission packets 104A to 104N, which makes it hardware-friendly.

In accordance with an embodiment, the data transmission method 300 further comprises limiting a number of frames per data transmission packet in the one or more data transmission packets 104A to 104N to a defined maximum number of frames per data transmission packet. In other words, the data transmission method 300 comprises defining an upper bound for the number of frames, such as the frames 106A and 106B in the one or more data transmission packets 104A to 104N. In an example, a maximum number of frames per data transmission packet is limited to two frames per data transmission packet 104A to 104N. Therefore, no additional frames (and headers) will exist deep within the received data transmission packets 104A and 104B, making it easy for hardware parsing of the modified QUIC protocol within the data transmission controller 102.

In accordance with an embodiment, the data transmission method 300 further comprises setting the number of frames per data transmission packet to the defined maximum number of frames per data transmission packet 104A to 104N. In other words, the data transmission method 300 comprises defining an upper bound for the number of frames per data transmission packet. In an example, a maximum number of frames per data transmission packet is set to two number of frames per data transmission packet, making it easy for hardware parsing of the modified QUIC protocol within the data transmission controller 102.

In accordance with an embodiment, the data transmission method 300 further comprises setting all the fields 108A to 108N of a field-type to fixed field-type size. In other words, the data transmission method 300 comprises setting the field-type of all the fields 108A to 108N to the fixed field-type size. Thus, different fields 108A to 108N of different field-type will have fixed field-type sizes, and the data transmission controller 102 does not require a complex iterative parsing to process the all fields 108A to 108N.

In accordance with an embodiment, the data transmission method 300 further comprises including a version number in the one or more data transmission packets 104A to 104N, the version number indicating a protocol version to be used. In other words, one or more data transmission packets 104A to 104N generated according to the modified QUIC protocol includes the version number indicating a protocol version to be used. In an example, the version number indicating the protocol version is used to enable identification of the modified QUIC protocol of the present disclosure which is also referred to as hardware offload variant of the QUIC protocol (or OQUIC).

In accordance with an embodiment, the data transmission method 300 further comprises including a mode in the one or more data transmission packets 104A to 104N, the mode indicating whether the data transmission packets 104A to 104N are to be encrypted or not. In other words, the mode (e.g., an unsecured mode of operation) included by the data transmission method 300 in the one or more data transmission packets 104A to 104N indicates whether one or more data transmission packets 104A to 104N are to be encrypted or not. In an example, encryption of one or more data transmission packets 104A to 104N is disabled in the mode, such as in the unsecured mode of operation, which may be used for internal domains and confined networks. Beneficially in comparison with the conventional approach, the data transmission method 300 with the hardware Offload variant of the QUIC protocol is not limited to encryption.

In accordance with an embodiment, the data transmission method 300 further includes a communication interface 110. The data transmission method 300 further comprises initiating a communication session with a communication device 112 over the communication interface 110. The data transmission method 300 further comprises defining communication parameters during initiation of the communication session, wherein the communication parameters comprises a field size and a frame-type order, and wherein the predefined number of frames is a limited number of frames negotiated on connection establishment with the communication device 112 based on the communication parameters. In other words, the data transmission method 300 comprises the communication interface 110, which is used to initiate the communication session (or connection establishment) with a communication device 112. Moreover, during the initiation of the communication session, the communication parameters are defined by the data transmission controller 102, where the communication parameters include the field size of the fields 108A to 108N and the frame-type order of the predefined number of frames, such as the frame 106A and 106B. Therefore, the field size of the fields 108A to 108N and the frame-type order of the frames could be fixed to the indicated size, such as negotiated to a smaller value based on the communication parameters during initiation of the communication session with the communication device 112. The communication parameters are further used to negotiate the predefined number of frames, such as the frame 106A and the frame 106B to a limited (or constant) number of frames on connection establishment with the communication device 112. Beneficially in comparison with the conventional QUIC protocol, the predefined number of frames in the modified QUIC protocol are constant after connection establishment negotiation, and also remain constant during the lifetime of the connection.

In accordance with an embodiment, the data transmission method 300 further comprises executing an application-program interface (API) with two modes: a stream-aware mode and a stream-unaware mode. In other words, the data transmission method 300 further comprises executing the application-program interface. Moreover, the application-program interface enables two modes of operation, such as the stream-aware mode and the stream-unaware mode. In an example, the stream-aware mode is aware of QUIC streams (e.g., QUIC streams of one or more data transmission packets 104A to 104N) and also allows an application (e.g., a web application) to define multiple QUIC streams. In contrast, the stream-unaware mode is not aware of the QUIC streams.

In accordance with an embodiment, the data transmission method 300 further comprises handling at least some of the generation in hardware. In other words, the data transmission method 300 further comprises handling at least some of the generation in hardware Offload variant of the modified QUIC protocol. Thus, the data transmission method 300 defines possible extensions to the conventional QUIC protocol (or a next-generation of transmission control protocol) that make it even more versatile in hardware implementations.

In accordance with an embodiment, the data transmission method 300 further comprises receiving a data transmission packet and parsing the received data transmission packet in a hardware. In other words, the data transmission method 300 further comprises receiving the data transmission packet, such as the data transmission packet 104A from a communication device such as communication device 112. Optionally, the beginning of the received data transmission packet includes all the headers and makes the data transmission method 300 hardware-oriented. Moreover, the data transmission method 300 defines a subset of the QUIC protocol that makes it hardware-friendly.

In accordance with an embodiment, a computer-readable medium carrying computer instructions that when loaded into and executed by a control circuitry 114 of a data transmission controller 102 enables the data transmission controller 102 to implement the data transmission method 300. In one aspect, a computer program product is provided comprising a non-transitory computer-readable medium having computer instructions stored thereon, the computer instructions being executable by the data transmission controller 102 to execute the data transmission method 300. Examples of implementation of the non-transitory computer-readable medium include, but is not limited to, Electrically Erasable Programmable Read-Only Memory (EEPROM), Random Access Memory (RAM), Read-Only Memory (ROM), Hard Disk Drive (HDD), Flash memory, a Secure Digital (SD) card, Solid-State Drive (SSD), a computer-readable storage medium, and/or CPU cache memory. The computer-readable medium for providing a non-transient memory may include, but is not limited to, an electronic storage device, a magnetic storage device, an optical storage device, an electromagnetic storage device, a semiconductor storage device, or any suitable combination of the foregoing.

Therefore, the data transmission method 300 uses a subset of the functionality of the QUIC protocol in a way that enables hardware offloading of the QUIC protocol. As the data transmission method 300 is configured to generate one or more data transmission packets 104A to 104N according to the modified QUIC (or OQUIC) protocol. Thus the data transmission method 300 does not need requires expensive resource consumption to run the modified QUIC protocol. Further, due to the fixed size of the fields 108A to 108N, the data transmission method 300 does not require the complex iterative parsing in order to process the one or more fields 108A to 108N, and also does not need to keep a per-connection state that includes the length of the respective fields 108A to 108N. The hardware Offloading of the QUIC protocol is used for remote direct memory access over QUIC elastic transport (RoQET), which is an alternative to remote direct memory access (RDMA)-over-converged-Ethernet (RoCE) that provides reliability and low latency and can be deployed over a wide area network (WAN). Another potential use case of the hardware Offloading of the QUIC protocol is non-volatile-memory-express (NVMe)-over-QUIC, which may be an alternative for non-volatile-memory-express (NVMe)-over-fabric, and NVMe-over-TCP which suffers from the TCP issued that QUIC came to solve.

The present disclosure provides efficient hardware implementations of the modified QUIC protocol. The data transmission method 300 further allows to significantly improve the performance of servers and hosts that run the modified QUIC protocol and provides a generic application-program interface to run various applications over hardware offloaded implementation. Thus, the present data transmission method 300 implementing the hardware Offload variant of the QUIC protocol (also termed as OQUIC) may potentially be standardized in the Internet Engineering Task Force (IETF) which may further influence and enhance a way people design, use, and manage the Internet.

FIG. 4 is a flowchart of a data transmission method for generating one or more data transmission packets according to the modified QUIC protocol, in accordance with another embodiment of the present disclosure. FIG. 4 is shown in conjunction with elements from FIGS. 1A, 1B, and 2. With respect to FIG. 4, there is shown a data transmission method 400 for generating one or more data transmission packets 104A to 104N according to the modified QUIC protocol. The data transmission method 400 includes steps 402 and 404.

In another aspect, the present disclosure provides a data transmission method 400 for generating one or more data transmission packets 104A to 104N according to the modified QUIC protocol, wherein the method comprises 400: receiving incoming data 202, the incoming data 202 comprising transmission control protocol (TCP) instructions 204 or user datagram protocol (UDP) instructions 206 and instructions 210 according to an application-program interface (API) 208; generating one or more data transmission packets 104A to 104N for the modified QUIC protocol according to the transmission control protocol (TCP) instructions 204 or user datagram protocol (UDP) instructions 206 and based on the instructions 210 according to the application-program interface (API) 208, wherein the application-program interface (API) 208 comprises two modes: a stream-aware mode 212 and a stream-unaware mode 214.

The present disclosure provides the data transmission method 400 for generating one or more data transmission packets 104A to 104N according to the modified QUIC protocol. As the data transmission method 400 is configured to generate one or more data transmission packets according to the modified QUIC protocol. Thus the data transmission method 400 does not need require expensive resource consumption to run the modified QUIC protocol. Moreover, the data transmission method 400 uses a subset of the functionality of QUIC in a way that enables hardware Offloading of the QUIC protocol.

At step 402, the data transmission method 400 comprises receiving incoming data 202, the incoming data 202 comprising transmission control protocol (TCP) instructions 204 or user datagram protocol (UDP) instructions 206, and instructions 210 according to an application-program interface (API) 208. In other words, the data transmission method 400 comprises receiving the incoming data 202, which includes the transmission control protocol instructions 204 (or user datagram protocol instructions 206), and the instructions 210 from the application-program interface 208. In an example, the incoming data 202 is received from a network sniffer such as wire, where both the stream aware and stream unaware modes are OQUIC packets, such as the data transmission packets 104A to 104N. Further, the conversion of the incoming data 202 is done on a software/firmware/hardware (SW/FW/HW) layer that changes the transmission control protocol instructions 204 to OQUIC and on the network sniffer the packets, such as the data transmission packets 104A to 104N will look as OQUIC packets. In other words, on the network sniffer (or wire), the incoming data 202 always includes OQUIC packets. In an implementation, the incoming data 202 includes a field size for the fields 108A to 108N and a predefined frame-type order for the frames, which is used by the data transmission method 400 to generate one or more data transmission packets 104A to 104N.

At step 404, the data transmission method 400 comprises generating one or more data transmission packets 104A to 104N for the modified QUIC protocol according to the transmission control protocol instructions 204 (or user datagram protocol instructions 206) and based on the instructions 210 according to the application-program interface (API) 208, wherein the application-program interface (API) 208 comprises two modes: a stream-aware mode 212 and a stream-unaware mode 214. In other words, the data transmission method 400 comprises receiving the incoming data 202 and generating one or more data transmission packets 104A to 104N for the modified QUIC protocol, such as to generate the data transmission packet 104A for the modified QUIC protocol. As the incoming data 202 includes the transmission control protocol instructions 204 (or user datagram protocol instructions 206) and the instructions 210 from the application-program interface 208. Therefore, the data transmission method 400 generates one or more data transmission packets 104A to 104N for the modified QUIC protocol according to the transmission control protocol instructions 204 (or user datagram protocol instructions 206), and also based on instructions 210 from the application-program interface 208. In an implementation, the application-program interface 208 is executed by the data transmission method 400, and the application-program interface 208 includes the stream-aware mode 212 and the stream-unaware mode 214. Therefore, the data transmission method 400 uses the modified QUIC protocol, such as the Offload variant of the QUIC protocol, which may be useful in performance sensitive environments, for example, hypertext transfer protocol secure (HTTPS) web servers. In addition, the data transmission method 400 may be used for non-HTTP applications also, that run over the conventional QUIC protocol as well. Thus, the data transmission method 400 provides and enables the generic socket-like application-program interface 208, which can enable applications to run over the modified QUIC protocol as a replacement to the conventional transmission control protocol (TCP), such as for the applications that require efficient resource consumption by using hardware offloading.

In an implementation, the data transmission method 400 executes the application-program interface 208 that may be designed in a versatile way that allows various application types to run over the Offload variant of the QUIC protocol. Examples of the application types include but are not limited to remote direct memory access (RDMA) and various other applications that are either from the stream-aware mode 212 or from the stream-unaware mode 214. Since the QUIC streams are a notion that does not exist in transmission control protocol, thus it is expected that legacy applications may need to run transparently over the data transmission method 400 with the Offload variant of the QUIC protocol in a stream-unaware manner. Moreover, the legacy applications, such as a secure shell protocol (SSH) (or file transfer protocol (FTP)) may run over the stream-unaware application-program interface in a way that allows smooth migration from existing implementations.

As the data transmission method 400 is configured to generate one or more data transmission packets 104A to 104N for the modified QUIC protocol. Thus, the data transmission method 400 does not need requires expensive resource consumption to run the modified QUIC protocol. Moreover, the data transmission method 400 uses a subset of the functionality of the QUIC protocol in a way that enables hardware offloading of the QUIC protocol.

In accordance with an embodiment, a computer-readable medium carrying computer instructions that when loaded into and executed by a control circuitry 114 of a data transmission controller 102 enables the data transmission controller 102 to implement the data transmission method 400. In one aspect, a computer program product is provided comprising a non-transitory computer-readable medium having computer instructions stored thereon, the computer instructions being executable by the data transmission controller 102 to execute the data transmission method 400. Examples of implementation of the non-transitory computer-readable medium include, but is not limited to, Electrically Erasable Programmable Read-Only Memory (EEPROM), Random Access Memory (RAM), Read-Only Memory (ROM), Hard Disk Drive (HDD), Flash memory, a Secure Digital (SD) card, Solid-State Drive (SSD), a computer-readable storage medium, and/or CPU cache memory. The computer-readable medium for providing a non-transient memory may include, but is not limited to, an electronic storage device, a magnetic storage device, an optical storage device, an electromagnetic storage device, a semiconductor storage device, or any suitable combination of the foregoing.

Therefore, the data transmission method 400 uses a subset of the functionality of the QUIC protocol in a way that enables hardware offloading of the QUIC protocol. The present disclosure provides efficient hardware implementations of the modified QUIC protocol. The data transmission method 400 further allows to significantly improve the performance of servers and hosts that run the modified QUIC protocol and provides a generic application-program interface 208 to run various applications over hardware offloaded implementation. Thus, the present data transmission method 400 implementing the hardware Offload variant of the QUIC protocol (also termed as OQUIC) may potentially be standardized in the Internet Engineering Task Force (IETF) which may further influence and enhance a way people design, use, and manage the Internet.

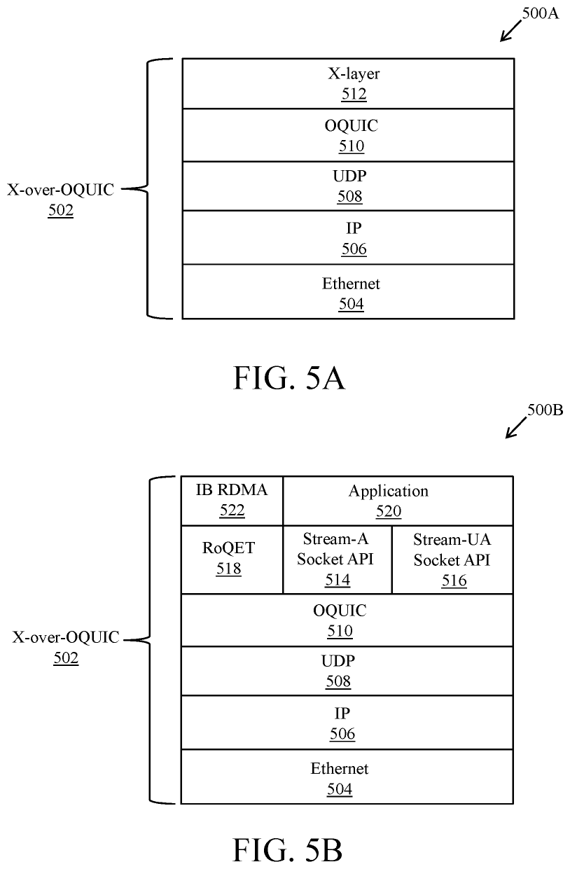

FIG. 5A is an illustration of an X-over-Offload variant of QUIC (OQUIC) application-program interface, in accordance with an embodiment of the present disclosure. FIG. 5A is shown in conjunction with elements from the FIGS. 1A, 1B and 2A. With respect to FIG. 5A, there is shown an illustration 500A of an X-over-Offload variant of QUIC (OQUIC) application-program interface 502 as a generic application-program interface. The X-over-Offload variant of QUIC application-program interface 502 includes an Ethernet layer 504, an internet protocol (IP) layer 506, a user datagram protocol (UDP) layer 508, Offload variant of QUIC layer 510, and an X-layer 512.

The Ethernet layer 504 provides a communication interface that is used to initiate a communication session with a communication device. The internet protocol layer 506 and the user datagram protocol layer 508 are communications protocols. The internet protocol layer 506 is used to encapsulate and deliver data from one point to other points, and the user datagram protocol layer 508 is used to establish low-latency and loss tolerating connections between applications on the internet. The internet protocol layer 506 may also be referred to as a transport control protocol.

The Offload variant of QUIC layer 510 is a subset of the QUIC protocol that makes it hardware-friendly. The Offload variant of QUIC layer 510 defines possible extensions to the conventional QUIC protocol that make it even more versatile in hardware implementations. The X-layer 512 corresponds to an application (e.g., a web application).

The X-over-Offload variant of QUIC application-program interface 502 corresponds to a generic socket-like application-program interface, which can enable applications to run over the modified QUIC protocol as a replacement to a transport control protocol. Therefore, the X-over-Offload variant of QUIC application-program interface 502 offloaded the expensive functionality (i.e., resource consumption) to hardware (e.g., a host that run the modified QUIC protocol).

FIG. 5B is an illustration of an X-over-Offload variant of QUIC (OQUIC) application-program interface, in accordance with another embodiment of the present disclosure. FIG. 5B is shown in conjunction with elements from the FIGS. 1A, 1B, 2A, and FIG. 5A. With respect to FIG. 5B, there is shown an illustration 500B of the X-over-Offload variant of QUIC (OQUIC) application-program interface 502 as the generic application-program interface. The X-over-Offload variant of QUIC application-program interface 502 includes a stream-aware socket application-program interface (API) 514, a stream-unaware socket application-program interface 516, InfiniB and (IB) remote direct memory access (RDMA) 518, an application 520, remote direct memory access over QUIC elastic transport (RoQET) 522, the Ethernet layer 504, the internet protocol (IP) layer 506, the user datagram protocol (UDP) layer 508, the Offload variant of QUIC layer 510, and the X-layer 512.

The stream-aware socket application-program interface 514 is aware of QUIC streams and allows the application, such as the application 520, to define multiple QUIC streams. However, the stream-unaware socket application-program interface 516 is not aware of the QUIC streams and does not allow the application, such as the application 520, to define multiple QUIC streams. The stream-unaware socket application-program interface 516 further have a layer that translates from TCP/UDP socket API to OQUIC.

The InfiniB and remote direct memory access 518 corresponds to an implementation of the remote direct memory access (RDMA) technology using the InfiniB and network. The remote direct memory access over QUIC elastic transport (RoQET) 522 is an alternative to remote direct memory access (RDMA)-over-converged-ethernet (RoCE) that provides reliability and low latency and can be deployed over a wide area network (WAN)

The X-over-Offload variant of QUIC application-program interface 502 provides the hardware offloading of the QUIC protocol, which is used for remote direct memory access over QUIC elastic transport (RoQET) 522. Another potential use case of the X-over-Offload variant of QUIC application-program interface 502 is non-volatile-memory-express (NVMe)-over-QUIC, which may be an alternative for non-volatile-memory-express (NVMe)-over-fabric, and NVMe-over-TCP which suffers from the TCP issue that QUIC came to solve.

In an implementation, the X-over-Offload variant of QUIC application-program interface 502 may be designed in a versatile way that allows various application types to run over X-over-Offload variant of QUIC application-program interface 502. Examples of the application types include but not limited to, a remote direct memory access (or InfiniB and remote direct memory access 518), and various other applications that are based on the stream-aware socket application-program interface 514 and the stream-unaware socket application-program interface 516. Since QUIC streams are a notion that does not exist in the transport control protocol, therefore, it is expected that legacy applications may need to run transparently over the X-over-Offload variant of QUIC application-program interface 502 in a stream-unaware manner, such as in the stream-unaware socket application-program interface 516. However, new applications may benefit from the use of multiple streams per connection. Therefore, the present disclosure provides the generic application-program interface, such as the X-over-Offload variant of QUIC application-program interface 502 for running various applications over hardware offloaded implementation.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

What is claimed is:

1. A data transmission controller, wherein the data transmission controller is configured to:
generate one or more data transmission packets according to a modified QUIC protocol, by
generating one or more fields in the one or more data transmission packets to have a fixed field-size, and
generating a predefined number of frames of different frame-types in a predefined frame-type order in the one or more data transmission packets.

2. The data transmission controller according to claim 1, wherein the data transmission controller is further configured to limit a number of frames per data transmission packet in the one or more data transmission packets to a defined maximum number of frames per data transmission packet.

3. The data transmission controller according to claim 2, wherein the data transmission controller is further configured to set the number of frames per data transmission packet to the defined maximum number of frames per data transmission packet.

4. The data transmission controller according to claim 1, wherein the data transmission controller is further configured to set all fields of a field-type to fixed field-type size.

5. The data transmission controller according to claim 1, wherein the data transmission controller is further configured to include a version number in the one or more data transmission packets, the version number indicating a protocol version to be used.

6. The data transmission controller according to claim 1, wherein the data transmission controller is further configured to include a mode in the one or more data transmission packets, the mode indicating whether the data transmission packets are to be encrypted or not.

7. The data transmission controller according to claim 1, further comprising a communication interface, wherein the data transmission controller is further configured to initiate a communication session with a communication device over the communication interface and to define communication parameters during initiation of the communication session, wherein the communication parameters comprises a field size and a frame-type order, and wherein the predefined number of frames is a limited number of frames negotiated on connection establishment with the communication device based on the communication parameters.

8. The data transmission controller according to claim 7, wherein the communication parameters further comprises a maximum number of frames per data transmission packet.

9. The data transmission controller according to claim 7, wherein the field size comprises one or more field-type sizes.

10. The data transmission controller according to claim 9, wherein at least one of the field-type sizes is zero.

11. The data transmission controller according to claim 7, wherein the communication parameters further comprises a parsing depth.

12. The data transmission controller according to claim 7, wherein the data transmission controller is further configured to negotiate one or more of the communication parameters with the communication device during initialization of the communication session.

13. The data transmission controller according to claim 1, wherein the data transmission controller is further configured to execute an application-program interface, API, with a stream-aware mode and a stream-unaware mode.

14. The data transmission controller according to claim 13, wherein the stream-aware mode is based on the generated one or more data transmission packets.

15. The data transmission controller according to claim 13, wherein the API is arranged for enabling applications designed for a transmission control protocol, TCP, and user datagram protocol, UDP, protocols to run on the modified QUIC protocol.

16. The data transmission controller according to claim 15, wherein the stream-unaware mode is a TCP Socket API.

17. The data transmission controller according to claim 15, wherein the stream-unaware mode is a UDP Socket API.

18. The data transmission controller according to claim 1, wherein the data transmission controller is configured to handle at least some of the generating in hardware.

19. The data transmission controller according to claim 1, wherein the data transmission controller is configured to receive a data transmission packet and to parse the received data transmission packet in hardware.

20. A data transmission method for generating one or more data transmission packets, comprises:
generating the one or more data transmission packets according to a modified QUIC protocol, by
generating one or more fields in the one or more data transmission packets to have a fixed field-size and
generating a predefined number of frames of different frame-types in a predefined frame-type order in the one or more data transmission packets.
